(19) United States
(12) Patent Application Publication
(10) Pub. No.: US 2007/0137484 A1
(43) Pub. Date: Jun. 21, 2007

(54) Operating room body gas evacuation system

(75) Inventor: Keith Roberts, White Bear Lake, MN (US)

Correspondence Address: Carl L. Johnson;Jacobson and Johnson, Suite 285, One West Water Street, St. Paul, MN, 55107, US

(73) Assignee: Porous Media

(21) Appl. No.: 11/607,081

(22) Filed: Dec. 1, 2006

Related U.S. Application Data
(60) Provisional application No. 60/753,195, filed on Dec. 21, 2005.

(51) Int. Cl. B01D 46/00

(52) U.S. Cl. 95/273; 55/385.1

(57) ABSTRACT

A operating room body gas evacuation system and method for the removal of carbon monoxide generated during a surgical procedure with the system including a trocar having an outlet connected to a carbon monoxide removal material to remove the carbon monoxide generated during the surgical procedure and if the air is humidified a desiccant to remove water vapor before flowing the body gas through the carbon monoxide removal material.

### CROSS REFERENCE TO RELATED APPLICATIONS

This application claims priority to U.S. Provisional Application Ser. No. 60/753,195, which was filed on Dec. 21, 2005.

### FIELD OF THE INVENTION

This invention relates generally to an evacuation system and, more specifically, to an in room operating room body gas evacuation system that can provide on-the-go removal of carbon monoxide from body gases generated during a surgical procedure.

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

Surgical smoke containing aerosol contaminates are produced during endoscopic surgery as a result of incomplete tissue combustion. The concept of a method and apparatus for evacuating carbon dioxide insufflation gas as well as contaminates in the body gases from a patient cavity during and after endoscopic surgery is well known in the art. For example, one approach is shown and described in U.S. Pat. No. 5,688,256. Briefly, an evacuation system is attached to an endoscope port and includes a flow valve, filter and or an aerosol trap. When the flow valve is opened one can release the body gas and contaminants, which are generated during the surgical procedure. The filter removes aerosolized particles such as blood and other body fluids allowing the cleaned body gas to pass into the atmosphere. In an alternate embodiment the body gasses and contaminates are trapped in a collection bag and then later disposed of.

Other prior art devices address the issue of the odiferous nature of surgical smoke while also removing the suspended particles in the surgical smoke. For example, U.S. Pat. Nos. 6,110,259 and 6,589,316, show a smoke filter device that includes an odor-reducing element such as activated carbon. While these devices are suitable for cleaning the body gas of suspended contaminates that can be sensed by a person they don't address or recognize the presence of unwanted gases that are not readily sensed by a person, such as carbon monoxide, which is a colorless and odorless gas that is generated as a result of the laparoscopic or endoscopic surgery.

The emergency removal of carbon monoxide from inhaled air through a device such as personal inhaler is known in the art of fire fighting. The personal inhaler, which is placed in the user's mouth, can remove the carbon monoxide before the carbon monoxide can be ingested into the person's lungs. By breathing through a personal inhaler device the firemen can provide a few minutes of additional breathing time if the firemen finds himself or herself in a smoke filled hallway or building. One such portable air purifier that removes carbon monoxide is shown in U.S. Pat. No. 5,690,101. The devices includes a tube with a filter material for removing particles and a carbon monoxide removal material located therein which allows a user to inhale through one end of the tube in order to draw the contaminated air through the filter to remove the smoke and other toxic particles as well as carbon monoxide gas. Such portable inhaler devices are suitable for emergency use for removing carbon monoxide and can also include filters for removal of toxic particles in conjunction with the carbon monoxide. Such personal inhaling device are not well suited for use by hospital staff, particularly, while surgery is in process. Rather than having a personal carbon monoxide filter device for each person it is preferred that the level of carbon monoxide in the operating room be kept at levels, which are considered non-toxic or non-harmful to the operating room personnel as well as the patient.

One of the problems with the incomplete tissue combustion that occurs during endoscopic surgery is that carbon monoxide, which is generated as a byproduct of the surgery, can pass directly through existing operating room body gas evacuation systems and into the operating room atmosphere since the operating room filter systems are generally designed to remove particles from the air rather than undesirable gases. However, the level of carbon monoxide in the patient increases since vented body gases contain carbon monoxide that can be absorbed and accumulate in the patient's blood during and after the laparoscopic procedure. In addition, the presence of carbon monoxide in the operating room can also present a hazard to the operating room staff if the filtered body operating room body gas evacuation system gas containing carbon monoxide gas is released into the operating room. That is, it is known that carbon monoxide adsorption and accumulation can lead to carbon monoxide poisoning, which can result in death.

Thus, to render the air in the operating room suitable for breathing a toxic gas such as carbon monoxide should be removed before the body gases are discharged into the operating room.

The present invention provides an operating room body gas evacuation system and method for ensuring removal of the carbon monoxide gas generated during a surgical procedure.

### SUMMARY OF THE INVENTION

An operating room body gas evacuation system for on-the-go removable of carbon monoxide generated during a surgical procedure with the system having a carbon monoxide removal material therein to remove carbon monoxide gas from the body gas before discharging the body gas into the operating room. To prolong the life of the operating room body gas evacuation system and inhibit carbon monoxide poisoning of a patient or the hospital staff in the operating room a desiccant can be placed upstream of the carbon monoxide removal material to remove water from the body gas to thereby ensure the continued efficacy of the carbon monoxide removal material. To determine if the carbon monoxide removable material in the body cavity evacuation system needs replenishment or if in the event of an operating room body gas evacuation system failure the operating room body gas evacuation system can be coupled with a stand alone inexpensive off-the-shelf carbon monoxide monitor which can be placed in the operating room to provide a visual or audible alarm if the carbon monoxide exceeds a predetermined level.

### BRIEF DESCRIPTION OF THE DRAWINGS

FIG. 1 is cross sectional view of an inline device for removing carbon monoxide;

FIG. 2 is a side view of a trocar system having an evacuation tube containing a carbon monoxide removal material;

FIG. 3 is a cross sectional view of a dual filter device for removal of contaminants in a carbon medium and for removal of carbon monoxide downstream of the carbon medium;

FIG. 4 is a cross sectional view of an operating room body gas evacuation system with a desiccant and odor removal material located in the evacuation line and a carbon monoxide removal device secured to the evacuation line to remove carbon monoxide from the gas flowing therethrough;

FIG. 5 is a cross sectional view of a replaceable evacuation line for an operating room body gas evacuation system with the evacuation line including an odor removing material proximate a carbon monoxide removing material so that gas flowing though the tubing removes particulate matter as well as carbon monoxide; and

FIG. 6 shows an operating room partially in schematic having an operating room body gas evacuation system of FIG. 4 removing unwanted gas and particles before discharging the gas into the operating room.

### DESCRIPTION OF THE PREFERRED EMBODIMENT

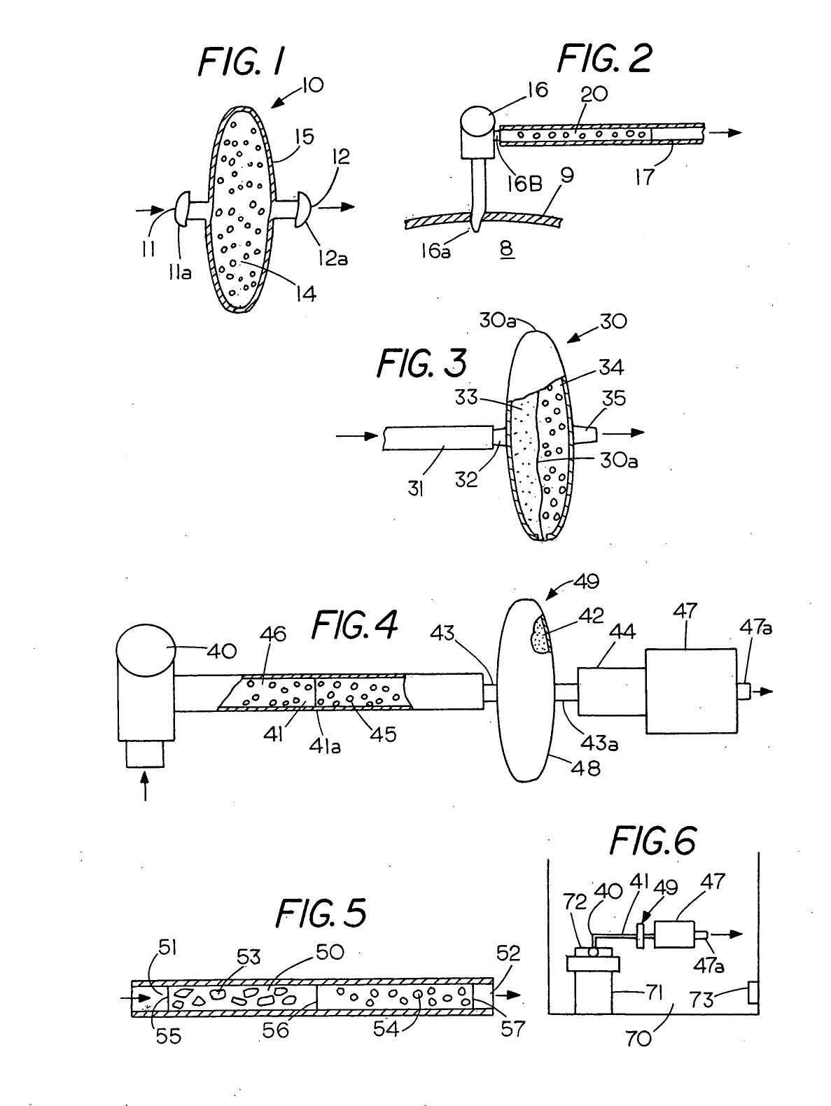

FIG. 1 shows an inline carbon monoxide removal device 10 for quickly attaching to a fluid line of an operating room body gas evacuation system for on-the-go evacuation of body gases from a body cavity, wherein the waste gases are generated as a result of surgery. For example, surgery with lasers or electrosurgical instruments creates a toxic aerosol, which is generally removed with a filter. While aerosols can generally be readily removed with a filter, a toxic gas such as carbon monoxide, which is a colorless, odorless, tasteless gas, cannot be easily detected and can flow undetected through existing filters. Although carbon monoxide is not readily noticeable, the presence of the carbon monoxide in the patient's body cavity can cause harm to the patient. In addition, the waste gases from the patient's body cavity are usually vented directly into the operating room causing the patient to be subject to the inhaling of the waste gases. The presence of waste gas, such as carbon monoxide, in the operating room can also create a toxic environment for the hospital staff. In order to address the problem of the presence of carbon monoxide in the operating room the invention incorporates a commercially available material capable of removing carbon monoxide gas into an operating room body cavity evacuation system that provides for on-the-go removal of carbon monoxide from the body gases. While the operating room body gas evacuation system can provide for on-the-go removal of carbon monoxide the operating room body gas evacuation system can also be used in other modes, which are not on-the-go.

In addition, one of the difficulties that can limit the efficacy of materials for removing unwanted carbon monoxide is the amount of humidity or moisture present in the body gas in the body cavity. This is particularly true when the insufflation gas injected into the body cavity is humidified to limit tissue damage during surgery. Consequently, flowing body gas from the body cavity through a carbon monoxide removal material can be ineffective since the presence of moisture in the gas can unknowingly reduce the efficacy of the carbon monoxide removal material. Since carbon monoxide is a colorless and tasteless gas it is an insidious gas not readily detected until people start losing consciousness. Also, because carbon monoxide is a colorless tasteless odorless gas it is generally, one of the materials not accounted for in operating room filter systems. Another of the materials not generally accounted for in operating room filter systems is the water vapor in the body gas removed from the body cavity since water vapor is often considered a harmless by product of the surgical process. However, the presence of water vapor in the body gas vented from the body cavity can have a secondary effect since the water vapor can reduce the efficacy of the material for removal of unwanted gasses from the discharged body gas.

The invention shown and described herein provides an operating room body gas evacuation system that removes carbon monoxide gas. In another embodiment the operating room body gas evacuation system also removes water vapor so as to retain the efficacy of the carbon monoxide removal material by use of a device that contains both a desiccant and a carbon monoxide removal material with the carbon monoxide removal material located downstream of the desiccant.

In the embodiment shown in section in FIG. 1, the carbon monoxide removal device 10 can be attached to an operating room body gas evacuation system with a flexible surgical tube or the like which is used to direct the gases away from the patients body. Device 10, which is shown partially in cross section, includes an inlet port 11 with an enlarged head 11a for slipping into one end of a flexible surgical tube and an outlet 12 with an enlarged head 12a for slipping onto the end of a second flexible surgical tube so that the gases can be directed through the carbon monoxide removal material 14 before being discharged into a filter or into the atmosphere of the operating room.

In the embodiments shown in FIG. 1, a carbon monoxide removal material 14 is held in housing 15 so that a gas entering inlet 11 must pass through the carbon monoxide removal material 14 before being discharged from outlet 12. Typically, the device 10 can be connected to an evacuation tube or housing that is connected to a trocar evacuation system having filters to remove toxic aerosol particles so that as the body cavity gasses flow though the trocar evacuation system the carbon monoxide can be removed from the body cavity gasses. Thus, a feature of the carbon removable device of FIG. 1 is that it can be quickly secured to an existing filtration system through coupling of the carbon monoxide removal device to the filtration system through use of flexible tubing that can resiliently engage the inlet head 11a and the outlet head 12a. Thus, the device 10 can be added as an after market device to a discharge vent of an existing filtration system without having to alter the filtration system. This type of device is particularly useful where the amount of water vapor in the body gas is low. Although device 10 is shown with heads for tubing coupling the device 10 it is envisioned that device 10 can be used with other attachment members such as couplings or pipe fittings.

FIG. 2 shows another embodiment of an operating room body gas evacuation system with a portion of a patient body cavity 8 having a trocar 16 with an end 16a that extends through body cavity wall 9 into the body cavity 8 of the patient. Typically, laser surgery or other electrosurgical procedures generate contaminants including a gas such as carbon monoxide in the body cavity 8. The trocar 16, which is used for the laposcopric surgery, can also be used for removal of the body gases from the body cavity 8 by connecting a side port 16b on the trocar 16 to an evacuation line or housing 17 that is shown partially in section to reveal the carbon monoxide removal material therein. In the embodiment shown in FIG. 2, a carbon monoxide removal material 20 is located in evacuation line 17 so that as gas leaves the trocar 16, it must pass through the carbon monoxide removal material 20 located therein. This embodiment provides inline removal of the carbon monoxide proximate the trocar as the body gasses are discharged from the body cavity. A vacuum source or vacuum pump can be located downstream of the trocar 16 and when necessary can be activated to help draw the waste body gasses from the body cavity so that the carbon monoxide can be removed soon after the body gas is discharged from the body cavity 8.

FIG. 3 shows in partial section an embodiment of a two component body gas evacuation device 30 that can be quickly coupled into an existing operating room body gas evacuation system through the use of flexible tubing or the like. In the embodiment shown the surgical evacuation tubing 31, which can be connected to a trocar or the like, connects to an inlet port 32 of evacuation device 30. Evacuation device 30 includes two materials, an activated carbon medium 33 to filter the gas of particles and a carbon monoxide removal material 34. Proximate to the carbon medium 33 and separating the carbon medium form the carbon monoxide removal material 34 is a gas permeable member 30a. Thus, the evacuation flow path of the device of FIG. 3 includes a carbon monoxide removal material 34 located in series with a carbon filter 33 so that device 30 can be quickly spliced into an existing fluid evacuation line to provide for removal of carbon monoxide as well as particulate matter in the body gas.

In operation, the body gas with the toxic materials flows through tube 31 and enters inlet 32 whereupon it flows through carbon medium 33 that removes harmful particles except the carbon monoxide gas. The body gas is then allowed to flow through the carbon monoxide removal material 34, which can comprise a commercially available material such as Hopcolite, which is a mixture of silver permaganate, copper oxide and nickel oxide. As the body gas flows through material 34 the carbon monoxide is removed from the body gas before the body gas exits from outlet 35. Thus, the embodiment of FIG. 3 provides an inline attachable device that can include at least two removal materials in with at least one of the removal materials comprising a carbon monoxide removal material that can be quickly and easily attached to an operating room body gas evacuation system.

FIG. 4 shows an operating room body gas evacuation system 49 partially in section comprising a trocar 40, which would be inserted into a body cavity. The entry end of the system 49 includes a surgical tube or housing 41, which can be frictionally connected to trocar 40 although other connection methods such as clamps or the like are within the scope of the present invention. The exhaust end of the operating room body gas evacuation system 49 includes a vacuum source 47 to provide suction to cause the body gasses to flow from the body cavity. In the embodiment shown in FIG. 4 a desiccant 46 is located in tube 41 to remove unwanted water from the body gas being discharged from the body cavity. Next to the desiccant 46 and separated by a gas permeable member 41a is a filter material 45 comprising activated carbon. In this embodiment the gas discharged from the body cavity travels through the desiccant 46 and then flows through the activated carbon 45. Located downstream of the carbon 45 is an inline carbon monoxide removable device 48 containing a carbon monoxide removable material 42 for removing carbon monoxide from the body gases flowing therethrough. A particulate filter 44 for removing particles can be located adjacent to the vacuum pump 47, As water vapor can be relatively harmful the embodiment of FIG. 4 shows the inclusion of an inline desiccant 46 to ensure that the efficacy of the carbon monoxide removal material 42. That is, efficacy of the carbon monoxide removal material is maintained since moisture is removed before it can adversely affect the carbon monoxide removable material. In addition, by having the desiccant upstream of the other filter mediums the efficacy of the other filter mediums one inhibits the water saturation of the filter mediums.

In embodiment of FIG. 4 the desiccant 46 removes moisture form the body gas before the body gas flows though the activated carbon 45, which removes odors and impurities in the body gas. After passing through the activated carbon 45, the body gas then flows into an inlet 43 and a chamber in carbon monoxide removal device 48, which contains a flow through carbon monoxide removal material 42, that removes the carbon monoxide from the body gas. Thus, FIG. 4 shows an operating room body gas evacuation system for the removal of moisture, odoriferous materials and carbon monoxide from the evacuated body gas by sequentially flowing the discharged body gasses through a desiccant, then a carbon medium and finally through a carbon monoxide removal material. To assist in removing the body gas from the body gas and to compensate for pressure loses through the various mediums a vacuum source or vacuum pump 47 can be used to draw the body gasses through the operating room body gas evacuation system 49.

The inclusion of a carbon monoxide adsorbent 42 such as Hopcolite, which is commercially available from Mine Safety Appliances Corporation, into a flow through device, allows one to remove carbon monoxide from the body gas. Other carbon monoxide removal materials such as Molecular Sieve Type 4A, Type 13X and calcium and sodium hydroxide can also be used to remove carbon monoxide. In addition, a carbon dioxide removal material can also be added to the operating room body gas evacuation system so that carbon dioxide can be removed. Thus the operating room body gas evacuation system can be used to remove gasses and particles with the system inhibited from loosing its efficacy due to moisture in the body gas.

Thus the operating room body gas evacuation system 49 for use during and after surgical procedures using laser cautery, electrosurgical procedures or the like that generate harmful body byproducts includes an evacuation tube such as a trocar 40, a fluid evacuation line or housing 46 coupled to the trocar; and a carbon monoxide removable material 42 located in the evacuation line 46 for removal of a carbon monoxide gas as a body gas is discharged therethrough.

FIG. 5 is an in line rigid evacuation tubing or housing 50 for use in an operating room body gas evacuation system with the tubing 50 including a desiccant 53 for removing moisture and a carbon monoxide removing material 54 located in line with the desiccant 53 so that body gas flowing though the tubing 50 enters inlet 51 and discharges through outlet 52 with carbon monoxide removed during the flow of the body gas through tubing 50. In this embodiment the rigid tubing can be quickly connected to the evacuation system through quick connect couplings or the like to allow insertion of fresh desiccant and carbon monoxide removal material as needed.

FIG. 6 shows partially in schematic an operating room 70 having an operating room body gas evacuation system 49 having a gas evacuation system 49 of FIG. 4 for removing unwanted gas and airborne particles before discharging the body gas into the operating room 70.

A patient 72 lies on an operating table 71 with the trocar 40 attached to the body cavity of the patient. The body gas, including aerosols, are discharged through tubing 41, which contains the carbon monoxide removable material, by a vacuum pump 47 that discharges the cleaned gas directly into the operating room through outlet 47a.

In order to ensure that the carbon monoxide gas in the operating room is kept below toxics levels a commercially available carbon monoxide monitor can be installed in the room 73. Thus not only does one more effectively remove the carbon monoxide from the body gas with the present invention but operating room body gas evacuation system can be used with an inexpensive carbon monoxide monitor to determine if the operating room body gas evacuation system is working properly. Thus the presence of a low cost commercially available carbon monoxide detector 73 that sends an alarm such as a visual or audible alarm if the carbon monoxide levels are too high can alerting the staff to unexpected problems or failures in the operating room body gas evacuation system.

Thus the present invention comprises a method of removing body gas from a patient during surgery comprising: placing an evacuation tube 40 in the body cavity; performing a surgical process that generates body gas containing carbon monoxide in the body cavity; and flowing the body gas from the body cavity 8 through a housing 48 containing a carbon monoxide removal material 42 to thereby retain the carbon monoxide in the housing before venting the body gas into the operating room.

Thus the invention includes an on-the-go in room operating room body gas evacuation system comprising a desiccant 46 a particulate filter medium 45; a carbon monoxide removing material 42; and a trocar 40 in fluid communication with the desiccant 46, the particulate filter medium 45 and the carbon monoxide removal material 42 to enable a body gas from a body cavity to be discharged through the desiccant, the particulate filter medium and the carbon monoxide removing material to thereby remove harmful particles as well as carbon monoxide gas from the body gas flowing therethrough.

If the insufflation pressure in the body cavity is sufficient one can discharge the gas to the atmosphere through the desiccant, the particulate filter medium and the carbon monoxide removing material the vacuum pump 47 may not be necessary.

I claim:

1. A operating room body gas evacuation system for use during and after surgical procedures using laser cautery, electrosurgical procedures or the like which can generate harmful body byproducts comprising:
a trocar;
a fluid evacuation line coupled to the trocar; and
a carbon monoxide removable material located in the evacuation line for removal of a carbon monoxide gas before the body gas is discharged to an atmosphere of the operating room.

2. The operating room body gas evacuation system of claim 1 including a particulate filter in series with the carbon monoxide removable material.

3. The operating room body gas evacuation system of claim 1 including an attachable housing containing the carbon monoxide removal material with the housing containing an inlet for receiving the body gas and an outlet for discharging the body gas while the carbon monoxide is retained therein by the carbon monoxide removable material.

4. The operating room body gas evacuation system of claim 1 wherein the evacuation line comprises a tube coupled to the trocar with the tube containing the carbon monoxide removable material and a desiccant.

5. The operating room body gas evacuation system of claim 4 including a particulate filter connected thereto to remove particles in the evacuated body gas and a vacuum source for drawing the body gas through the system.

6. The operating room body gas evacuation system of claim 5 including a bed of activated carbon in the system.

7. The operating room body gas evacuation system of claim 1 including a desiccant located in the body gas evacuation system with the desiccant located upstream of the carbon removable material to thereby remove moisture from the body gas before the body gas enters the carbon monoxide removable material.

8. An on-the-go in room operating room body gas evacuation system comprising:
a desiccant;
a particulate filter medium;
a carbon monoxide removing material; and
a trocar in fluid communication with the desiccant, the particulate filter medium and the carbon monoxide removal material to enable a body gas from a body cavity to be discharged through the desiccant, the particulate filter medium and the carbon monoxide removing material to thereby remove harmful particles as well as carbon monoxide gas from the body gas flowing therethrough.

9. The on-the-go operating room body gas evacuation system of claim 8 wherein the pressure in the body cavity is sufficient to discharge the gas to the atmosphere through the desiccant, the particulate filter medium and the carbon monoxide removing material.

10. The on-the-go operating room body gas evacuation system of claim 8 including an odor removing material contained in a fluid conduit in the system.

11. The on-the-go operating room body gas evacuation system of claim 10 wherein the odor removing material is activated carbon.

12. The on-the-go operating room body gas evacuation system of claim 8 including a carbon dioxide removing material.

13. The on-the-go operating room body gas evacuation system of claim 8 wherein the desiccant for the removal of moisture is located upstream of the carbon monoxide removing material.

14. The on-the-go operating room body gas evacuation system of claim 8 including a carbon monoxide monitor for providing a visual or audible alarm when the carbon monoxide in an operating room exceeds a preset level.

15. The on-the-go operating room body gas evacuation system of claim 8 wherein the carbon monoxide removal material and the desiccant are located in a housing that can be quickly coupled into the operating room body gas evacuation system.

16. The method of removing body gas from a patient during surgery comprising:
placing an evacuation tube in the body cavity;
performing a surgical process in the body cavity that generates a body gas containing a carbon monoxide gas; and
flowing the body gas from the body cavity through a housing containing a carbon monoxide removal material to thereby retain the carbon monoxide gas in the housing before discharging the body gas into an operating room.

17. The method of claim 16 including the step of first flowing the body gas through a desiccant to remove moisture from the body gas before removing the carbon monoxide gas from the body gas.

18. The method of claim 17 including flowing the body gas through a filter to remove particles from the body gas before discharging the body gas into an operating room.

19. The method of claim 18 including monitoring the level of carbon monoxide in the operating room with an in room carbon monoxide detector.

20. The method of claim 19 including replacing the housing with a further housing containing a further carbon monoxide removable material if the carbon monoxide monitor indicates the carbon monoxide level has exceeded a harmful level.

21. The method of claim 18 wherein the step of placing an evacuation tubes comprises placing a trocar with an evacuation port in the body cavity.
